(19) United States
(12) Patent Application Publication
(10) Pub. No.: US 2012/0316264 A1
(43) Pub. Date: Dec. 13, 2012

(54) METHOD OF MANUFACTURING ORGANIC MONTMORILLONITE

(75) Inventors: Xun WANG, Songjiang EPZ Shanghai (CN); Jin-Chang Wu, New Taipei City (TW); Wen-Bing Wang, Songjiang EPZ Shanghai (CN); Xin Wang, Songjiang EPZ Shanghai (CN)

(73) Assignees: Tech-Front (Shanghai) Computer Co. Ltd., Shanghai (CN); Quanta Computer Inc., Taoyuan Shien (TW)

(21) Appl. No.: 13/314,585

(22) Filed: Dec. 8, 2011

(30) Foreign Application Priority Data
Jun. 8, 2011 (CN) 201110152537.6

(51) Int. Cl. C07F 7/21; C08K 5/5415; C08L 63/00

(52) U.S. Cl. 523/456; 556/425

(57) ABSTRACT

A method of manufacturing an organic montmorillonite is disclosed. The manufacturing method includes the steps hereinafter. A montmorillonite solution and an intercalation agent solution are prepared respectively. The montmorillonite solution and the intercalation agent solution are mixed at high temperature to form an organic montmorillonite solution. The organic montmorillonite is purified to obtain an organic montmorillonite solution.

### RELATED APPLICATIONS

This application claims priority to China Application Serial Number 201110152537.6, filed Jun. 8, 2011, which is herein incorporated by reference.

### BACKGROUND

1. Field of Invention

The present invention relates to a method of manufacturing a modified montmorillonite. More particularly, the present invention relates to an organic montmorillonite.

2. Description of Related Art

Since epoxy is a polymer presenting good adhesive, thermosetting, mechanical and dielectric properties, epoxy has been widely applied in a printed circuit board and a package material of electronic devices.

Epoxy is a water absorbable material. When epoxy is applied in the printed circuit board, the printed circuit board may have pad craters, huge voids or altered dielectric constant resulting from absorbing water. On the other hand, epoxy may present brittleness, which may produce granules or powders after being cured. Such granules or powders of a cured epoxy may cause short circuit or failure of the electronic devices and further resulting in a poor production yield and other issues.

To solve the problems above, a conventional modified epoxy is prepared by mixing epoxy with inorganic fillers, such as aluminum hydroxide, titanium dioxide or silica antimony trioxide. However, the properties of the conventional modified epoxy are not significantly improved. The dielectric constant of the modified epoxy is increased as applying with inorganic fillers. Therefore, applications of the conventional modified epoxy are limited.

### SUMMARY

Therefore, the present disclosure directs to a method of manufacturing an organic montmorillonite. The method of manufacturing the organic montmorillonite includes step below. An inorganic montmorillonite is dispensed in water to form an inorganic montmorillonite solution. An intercalation agent is dissolved in water to form an intercalation agent solution. The inorganic montmorillonite solution is mixed with the intercalation agent solution uniformly to form an organic montmorillonite solution by an ultrasonication and a mechanical agitation. The organic montmorillonite solution is purified.

The present disclosure is directs to an organic montmorillonite-epoxy composite, which comprises an organic montmorillonite prepared by the above-mentioned method and an epoxy.

Besides, the present disclosure is also directs to another method of manufacturing an organic montmorillonite, and the method comprises steps below. An inorganic montmorillonite is dispersed in water to form an inorganic montmorillonite solution. An intercalation agent is dissolved in water to form an intercalation agent solution, where the intercalation agent to the inorganic montmorillonite is about 50-70 w/w %. The inorganic montmorillonite solution is ultrasonicated thereby forming a swollen inorganic montmorillonite solution. The swollen inorganic montmorillonite solution and the intercalation agent solution are mixed by mechanical agitation at a temperature of 60-80° C. to form an organic montmorillonite solution. The organic montmorillonite solution is purified to obtain an organic montmorillonite.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow chart of a method of manufacturing an organic montmorillonite according to one embodiment of the present disclosure.

FIG. 2 is a flow chart of a method of manufacturing an organic montmorillonite according to another embodiment of the present disclosure.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

References in the singular may also include the plural (for example, “a” and “an” may refer to one, or one or more) unless the context specifically states otherwise. The use of numerical values in the various ranges specified in this application, unless expressly indicated otherwise, are stated as approximations as though the minimum and maximum values within the stated ranges were both preceded by the word “about”. In this manner, slight variations above and below the stated ranges can be used to achieve substantially the same results as values within the ranges. Also, the disclosure of these ranges is intended as a continuous range including every value between the minimum and maximum values.

### Structure of an Organic Montmorillonite and an Organic Montmorillonite-Epoxy Composite

An inorganic montmorillonite is a kind of phyllosilicate clay. Each layer is primary composed of two silica tetrahedral sheets sandwiching an aluminum octahedral sheet in a ratio of 2:1, i.e. two layers of silica tetrahedral sheets sandwiching one layer of aluminum octahedral sheet. A structure of the silica tetrahedral sheet is composed of horizontally linked tetrahedral units, and each of the tetrahedral units consists of a central silicon atom surrounded by four oxygen atoms. Three oxygen atoms of each tetrahedral unit above are individually shared with neighboring tetrahedral units. The aluminum octahedral sheet is composed of horizontally linked octahedral-shaped units, and each of the octahedral units consists of an aluminum atom surrounded by six hydroxyls.

An organic ammonium ions (a kind of the intercalation agent) has a hydrophobic alkyl chain in one end and a positively charged amino group in another end. The organic ammonium ions and intercalated cations, such as Na⁺ or K⁺, of the inorganic montmorillonite may be ion exchanged when the organic ammonium ions and the inorganic montmorillonite are mixed. Therefore, the organic ammonium ions may intercalate into an interlayer spacings (d-spacing) of the inorganic montmorillonite. Once the d-spacing of the inorganic montmorillonite is enlarged to a certain extent, the hydrophobic alkyl chains of organic ammonium ions start to aggregate and stack together to further increase the d-spacing. Therefore, the inorganic montmorillonite is exfoliated to form an organic montmorillonite.

Moreover, the present disclosure also presents an organic montmorillonite-epoxy composite. The organic montmorillonite-epoxy composite may be manufactured by mixing the above-mentioned organic montmorillonite with epoxy. When mixing the organic montmorillonite with epoxy, an epoxy monomer or an epoxy side chain may enter into the enlarged d-spacing of the organic montmorillonite to exfoliate the organic montmorillonite. Thus, the epoxy can be uniformly mixed with the exfoliated organic montmorillonite to form hydrophobic organic montmorillonite-epoxy composite.

### Method of Manufacturing an Organic Montmorillonite

There are two methods for manufacturing the organic montmorillonite. One is ultrasonicating the inorganic montmorillonite solution in water to form a swollen inorganic montmorillonite solution, and the swollen inorganic montmorillonite solution and the intercalation agent solution are then mechanical agitated to mix. The other one is directly mixing the inorganic montmorillonite solution and the intercalation agent solution.

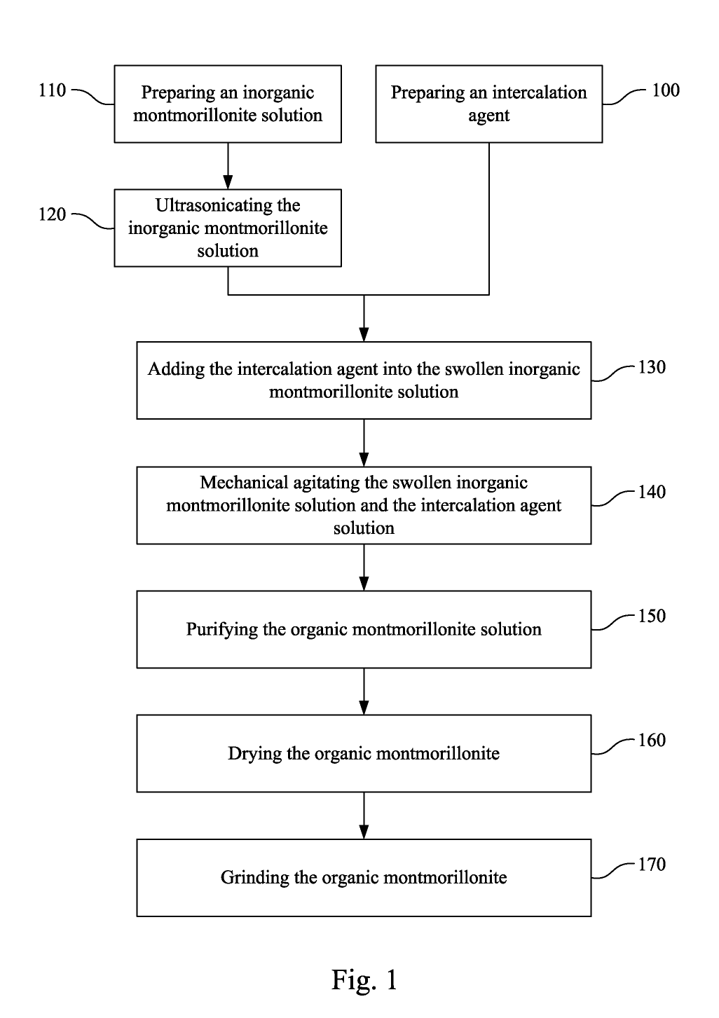

Referring to FIG. 1, which is a flow chart of manufacturing the organic montmorillonite according to one embodiment of the present disclosure. The method of manufacturing the organic montmorillonite comprises steps 100-170. In this method, the inorganic montmorillonite solution is ultrasonicated in water to form the swollen inorganic montmorillonite solution, and the swollen inorganic montmorillonite solution and the intercalation agent solution are then mechanical agitated for mixing.

In step 100, the intercalation agent is dissolved in water to form the intercalation agent solution. In one embodiment, a weight ratio of the intercalation agent to the inorganic montmorillonite is about 50-70 w/w %. In this embodiment, the intercalation agent is an alkyl trimethyl ammonium bromide. In one embodiment, the alkyl trimethyl ammonium bromide has 12-18 carbon atoms in alkyl group. For example, the alkyl trimethyl ammonium bromide may be dodecyl trimethyl ammonium bromide (DTAB), hexadecyl trimethyl ammonium bromide (CTAB), octadecyl trimethyl ammonium bromide (OTAB), stearyl trimethyl ammonium bromide (STAB) or combinations above.

Optionally, a suitable amount of a co-intercalation agent can be added into the intercalation agent solution to facilitate intercalation agent entering into the interlayer of the inorganic montmorillonite. For example, when the applied intercalation agent is CTAB, a suitable amount of nonylphenoxy ether (a co-intercalation agent) may be added to the intercalation agent solution,

In step 110, the inorganic montmorillonite is dispersed in water and then adjusted to a suitable pH value to form the inorganic montmorillonite solution. In some embodiments, the mixing ratio of the inorganic montmorillonite to water is less than 90 w/v %. In one or more embodiments, the inorganic montmorillonite may be sodium montmorillonite, potassium montmorillonite or a combination thereof. In one embodiment, the cation exchange capacity (CEC) of the inorganic montmorillonite is 70-100 mmol/100 g. The pH value of the inorganic montmorillonite solution may affect the CEC of the inorganic montmorillonite. In one or more embodiments, the inorganic montmorillonite solution has a pH value in a range of 5.5-8.

In step 120, the inorganic montmorillonite solution is ultrasonicated to form a swollen inorganic montmorillonite solution.

In step 130, the intercalation agent solution is added to the swollen inorganic montmorillonite solution.

In step 140, the swollen inorganic montmorillonite solution of step 120 and the intercalation agent solution of step 100 are mixed uniformly by mechanical agitation. In this step, the intercalation agent may ion exchange with sodium ion or potassium ion of the inorganic montmorillonite. In some embodiments, the swollen inorganic montmorillonite solution and the intercalation agent solution are mixed at high temperature. In one embodiment, the inorganic montmorillonite solution and the intercalation agent solution is mixed at a temperature of about 60-80° C.

In one or more embodiments, step 130 and step 140 may be performed in one step, i.e. the intercalation agent solution can be added into the swollen inorganic montmorillonite solution while mechanical agitating the swollen inorganic montmorillonite solution.

In addition, an ultrasonication time of the step 120 and a mechanical agitation time of the step 140 depend on the water volume, mixing temperature or agitator type. In one embodiment, a ratio of an ultrasonication time of step 120 to a mechanical agitation time of step 140 is 1:4. For example, the inorganic montmorillonite solution may be ultrasonicated for 1 hour at step 120, and then followed by 4 hours of mechanical agitation at step 140.

In step 150, the organic montmorillonite solution is purified to obtain the organic montmorillonite. The purification process could be done by a vacuum filtration or a centrifugation. A suitable pore size of a filtration membrane is selected based on a granule size of the inorganic montmorillonite. In one embodiment, when the applied inorganic montmorillonite has a granule size of 75 μm, a quantitative filter paper with medium speed (pore size 30-50 μm) or a quantitative filter paper with low speed (pore size 1-3 μm) may be selected as the filter membrane. Step 150 may be performed repeatedly to wash away the unreacted intercalation agent. The organic montmorillonite can be washed with water/deionized water and filtrated repeatedly, until there is no AgCl precipitant while adding silver nitrate to a washed water.

In step 160, the organic montmorillonite is dried. Drying the organic montmorillonite can be done by any suitable drying process, such as vacuum drying or atmospheric drying. In step 170, the dried organic montmorillonite is grinded to obtain the organic montmorillonite powder.

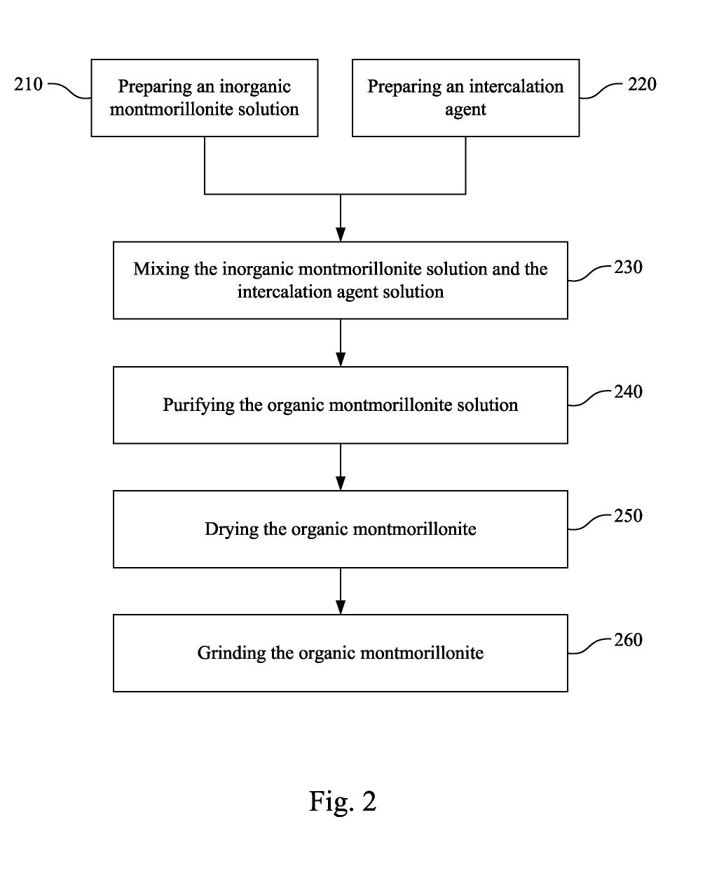

Referring to FIG. 2, which is a flow chart of a method of manufacturing an organic montmorillonite according to another embodiment of the present disclosure. In this embodiment, the mixing method of the intercalation agent solution and the organic montmorillonite solution are different from the method depicted in FIG. 1. Steps 210, 220 and 240-260 of FIG. 2 are same as steps 110, 100 and 150-170 of FIG. 1 respectively, thus detail description of those steps are omitted herein.

In step 230, the intercalation agent solution is directly added into the inorganic montmorillonite solution, and the intercalation agent solution and the inorganic montmorillonite solution are then mixed by the ultrasonication and the mechanical agitation. In one embodiment, a ratio of the ultrasonication time to the mechanical agitation time is 1:4. For example, the intercalation agent solution can be added into the inorganic montmorillonite solution, and then the intercalation agent solution is mixed with and the inorganic montmorillonite solution by 1 hour of the ultrasonication and 4 hr of the mechanical agitation.

In some embodiments, the inorganic montmorillonite solution and the intercalation agent solution are mixed at high temperature. In one embodiment, the inorganic montmorillonite solution and the intercalation agent solution are mixed at a temperature of about 60-80° C. In one or more embodiments, the obtained organic montmorillonite above can be mixed with epoxy to form an organic montmorillonite-epoxy composite. The organic montmorillonite-epoxy composite can be widely applied as the adhesive or the packaging material of electric devices.

### EXAMPLES

The following examples are provided for making the understanding of the present invention easier, although they are only for exemplification and are not intended to limit the characteristic feature of the present invention thereto. The term “parts” and “percentages” used in the examples are those by weight unless otherwise stipulated.

In this example, to evaluate three parameters of manufacturing process, an orthogonal experiential design is presented herein. Three parameters, weight ratio of the intercalation agent to the inorganic montmorillonite, mixing time and the pH value of the inorganic montmorillonite solution are evaluated. The manufacturing methods of the organic montmorillonite are referred to FIG. 1 and FIG. 2, where “swollen” and “non-swollen” presented in Table 1 represent the manufacturing methods of FIG. 1 and FIG. 2 respectively. The applied intercalation agent was CTAB, and the inorganic montmorillonite was sodium montmorillonite. The amount of CTAB to the inorganic montmorillonite, the pH value of inorganic montmorillonite solution and the mixing time are all listed on Table 1. The inorganic montmorillonite solution and the intercalation agent solution were mixed at 70° C. The frequency of the ultrasonication is 40 KHz and the speed of the mechanical agitation is 200 rpm. The drying process is performed at 80° C. for 6 hr.

The organic montmorillonites were then dried and grinded in sequence. The d-spacings of the organic montmorillonite powders were then analyzed by X-ray diffraction (XRD). K_{α} line of Cu, having a wavelength of 1.5406 Å, was used as a light source of the XRD. The X-ray results were then calculated by Bragg's equation to obtain d-spacings of Examples. Two different d-spacings, a primary d-spacing and a secondary d-spacing, of the organic montmorillonites are observed, and they are shown in Table 1.

TABLE 1
Orthogonal experiential conditions and d-spacings data

| | | | pH value of | | |
|---|---|---|---|---|---|
| | | | the | | |
| | CTAB/ | ultrasonication:mechanical | inorganic | d-spacing | |
| | montmorillonite | agitation | montmorillonite | (nm) | |
| Example | wt % | time ratio (hr) | solution | primary | secondary |
| 1 | 50 | 1 (swollen):4 | — | 3.86 | 1.93 |
| 2 | 50 | 1 (non-swollen):4 | 6 | 3.86 | 1.98 |
| 3 | 50 | 0:4 | 7 | 3.75 | 1.94 |
| 4 | 60 | 1 (swollen):4 | 6 | 3.84 | 1.93 |
| 5 | 60 | 1 (non-swollen):4 | 7 | 3.80 | 1.93 |
| 6 | 60 | 0:4 | — | 3.74 | 1.92 |
| 7 | 70 | 1 (swollen):4 | 7 | 3.97 | 1.96 |
| 8 | 70 | 1 (non-swollen):4 | — | 3.96 | 1.92 |
| 9 | 70 | 0:4 | 6 | 3.97 | 1.92 |

The organic montmorillonites of examples 1-9 have the primary d-spacings of about 3.74-3.97 nm and the secondary d-spacings of about 1.92-1.98 nm. Example 7 present a better result, the primary d-spacing is of about 3.97 nm and the secondary d-spacing is of about 1.96 nm of Example 7.

As disclosed above, the methods of manufacturing the organic montmorillonite are provided in the present disclosure. The organic montmorillonite of the present disclosure has a larger d-spacing in comparing to the conventional montmorillonite layers, which is suitable for mixing with epoxy and to form a better exfoliation in the montmorillonite-epoxy composite. Therefore, the montmorillonite-epoxy composite of the present disclosure could solve the problems that existing in the conventional modified epoxy. The settlement of the organic montmorillonite in epoxy could be eased. Granules or powders of the cured montmorillonite-epoxy composite could be less produced so as to increase the yield of electronic devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of manufacturing an organic montmorillonite, comprising:
dispersing an inorganic montmorillonite in water to form an inorganic montmorillonite solution;
dissolving an intercalation agent in water to form an intercalation agent solution;
mixing the inorganic montmorillonite solution and the intercalation agent solution uniformly to form an organic montmorillonite solution by an ultrasonication and a mechanically agitation; and
purifying the organic montmorillonite solution to obtain the organic montmorillonite.

2. The method of claim 1, wherein the inorganic montmorillonite solution has a concentration less than 90 w/v % and a pH value of 5.5-8.

3. The method of claim 1, wherein the intercalation agent to the inorganic montmorillonite is about 50-70 w/w %.

4. The method of claim 1, wherein mixing the inorganic montmorillonite solution and the intercalation agent solution is at a temperature of 60-80° C.

5. The method of claim 1, wherein the inorganic montmorillonite is sodium montmorillonite, potassium montmorillonite or a combination thereof.

6. The method of claim 1, wherein the intercalation agent is an alkyl trimethyl ammonium bromide, and the alkyl trimethyl ammonium bromide has 12-18 carbon atoms in alkyl group.

7. The method of claim 1, wherein an ultrasonication time to a mechanical agitation time is 1:4.

8. The method of claim 1, further comprising drying the organic montmorillonite.

9. The method of claim 1, further comprising grinding the organic montmorillonite.

10. The method of claim 1, further comprising mixing the organic montmorillonite with an epoxy thereby forming an organic montmorillonite-epoxy composite.

11. An organic montmorillonite-epoxy composite comprising:
an organic montmorillonite, wherein the organic montmorillonite is manufactured by the method of claim 1; and
an epoxy.

12. A method of manufacturing an organic montmorillonite comprising:
dispersing an inorganic montmorillonite in water to form an inorganic montmorillonite solution;
dissolving an intercalation agent in water to form an intercalation agent solution;
ultrasonicating the inorganic montmorillonite solution thereby forming a swollen inorganic montmorillonite solution;
mechanical agitating the swollen inorganic montmorillonite solution and the intercalation agent solution at a temperature of 60-80° C. thereby forming an organic montmorillonite solution; and
purifying the organic montmorillonite solution to obtain an organic montmorillonite.

13. The method of claim 12, wherein the intercalation agent to the inorganic montmorillonite is about 50-70 w/w %

14. The method of claim 12, wherein the inorganic montmorillonite solution has a concentration less than 90 w/v % and a pH value of 5.5-8.

15. The method of claim 12, wherein the inorganic montmorillonite is sodium montmorillonite, potassium montmorillonite or a combination above.

16. The method of claim 12, wherein the intercalation agent is an alkyl trimethyl ammonium bromide, and the alkyl trimethyl ammonium bromide has 12-18 carbon atoms in alkyl group.

17. The method of claim 12, wherein an ultrasonication time to a mechanical agitation time is 1:4.

18. The method of claim 12, further comprising drying the organic montmorillonite.

19. The method of claim 12, further comprising grinding the organic montmorillonite.

20. The method of claim 12, further comprising mixing the organic montmorillonite with epoxy to form an organic montmorillonite-epoxy composite.
